(19) United States
(12) Patent Application Publication
(10) Pub. No.: US 2010/0049701 A1
(43) Pub. Date: Feb. 25, 2010

(54) System Monitoring Control Point Conversions to Pervasive Device Objects

(75) Inventors: John Williams Miller, Suwanne, GA (US); Shelia Veal, Marietta, GA (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 12/195,915

(22) Filed: Aug. 21, 2008

(51) Int. Cl. G06F 17/30

(52) U.S. Cl. 707/4; 707/E17.062

(57) ABSTRACT

An embodiment of the invention receives first data from a network, wherein the first data is in a first protocol that is not readable by a user interface. The first data is translated into second data in a second protocol that is not readable by the user interface. The method accesses code lookup tables within a translation component to translate the first data into the second data. The second data is enriched with metadata that is specific to the first data, wherein the metadata is obtained from the translation component. The second data is translated into third data in a third protocol that is readable by the user interface. The method creates XSLT's to translate the second data to the third data and sends the third data to the user interface.

### I. FIELD OF THE INVENTION

The present invention is in the field of methods and computer program products for real-time alerting of control points and sensors inside of a system via a convenient display device, such as, a cell phone, personal digital assistant (PDA), or other pervasive devices.

### II. BACKGROUND OF THE INVENTION

Control points and sensor data for a monitored system can be accessed via a network embedded inside of the system. Early alerts of trouble arising in the system are sometimes available; however, such alerts are in a format that is not understandable by the average consumer, but requires specialized knowledge to diagnose and detect problems. For example, in the car repair industry, a specialized interface for communicating with the controller-area network (CAN) of a vehicle is required. As such, in this example, the information is not available to the average consumer.

### III. SUMMARY OF THE INVENTION

An embodiment of the invention interfaces to a network of the system in question and provides a gateway protocol translation function that enables the sensor data, routed within that system network, to be translated and enriched with metadata. The translation function is used to convert proprietary object data from the proprietary systems being interfaced, to structured Extensible Markup Language (XML) that follows the translation component/XML schema that can be stylized using Extensible Stylesheet Language Transformations (XSLT) to support any pervasive device targeted.

An embodiment of the invention provides personalized and secured access to the system being monitored, such as, for example, a car, house, or boat, and supports alerts and real-time queries of the system in question, via common, personal pervasive devices in an easy to use fashion.

Systems of at least one embodiment of the invention will not only provide an interface to the proprietary network that routes this control point and/or sensor data, but will also translate it to communication protocols that are more commonly used by pervasive devices. In addition, in at least one embodiment, the specialized metadata that enriches the sensor data collected will make problem identification and resolution much faster and interpretable by a larger group of people that do not require the specialized training.

In addition, an embodiment of the invention provides a protocol translation engine that enriches the data with metadata that translates between the proprietary protocols and common pervasive protocols. The engine will interface to the system network and will be in compliance with all electrical and mechanical specifications for interfacing.

### IV. BRIEF DESCRIPTION OF THE DRAWINGS

The present invention is described with reference to the accompanying drawings. In the drawings, like reference numbers indicate identical or functionally similar elements.

FIG. 1 is a diagram illustrating a plurality of sensors for monitoring a system network having a protocol/metadata engine according to one embodiment of the invention;

FIG. 2 is a diagram illustrating a protocol/metadata engine according to one embodiment of the invention;

FIG. 3 is a flow diagram illustrating a method for system monitoring control point conversions to pervasive device objects; and

FIG. 4 illustrates a computer program product according to one embodiment of the invention.

### V. DETAILED DESCRIPTION OF THE DRAWINGS

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

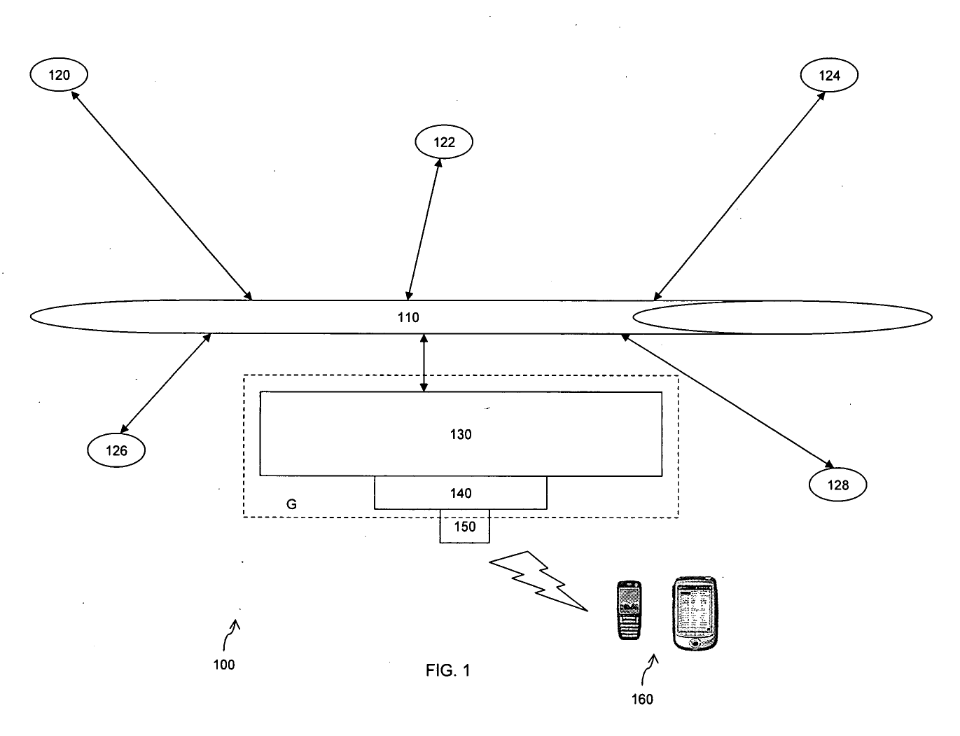

An embodiment of the present invention as illustrated in FIG. 1 includes an interface to a system network 110 connected to a gateway protocol translation function 132 that enables sensor data from sensors 120-128, routed within the system network 110, to be translated and enriched with specialized metadata. Personalized and secured access to the system 110 being monitored, for example, in a house, car, or boat, can be provided to common personal pervasive devices 160 in remote locations. Moreover, alerts and real time queries of the monitored system are supported in the pervasive devices 160 in an easy to use fashion.

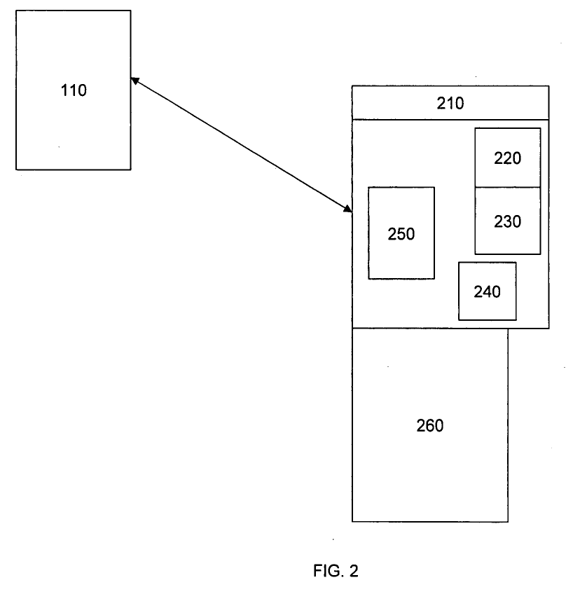

FIG. 2 includes a detailed description of a metadata engine (also referred to herein as “protocol translation engine”) 200. Specialized metadata is utilized that enriches the sensor data collected, thereby making problem identification and resolution much faster and interpretable by a larger group of people that do not require specialized training. As described in further detail below, the protocol translation engine 200 enriches the data with the specialized metadata and translates between the proprietary protocols and common pervasive protocols. The protocol translation engine 200 interfaces with the system network 110 (i.e., CAN, X10, FlexRay™). The electrical and mechanical specifications of the protocol translation engine 200 are adapted to interface with the system network. Specifically, the protocol translation engine 200 is compatible with the Institute of Electrical and Electronics Engineers (IEEE) and Electromagnetic Compatibility (EMC) standards (Guide to the demonstration of conformity for aftermarket Electric/electronic Sub-Assemblies (ESAs) to the motor vehicle EMC Directive 2004/104/EC) per device connected to in order to protect circuitry and fuses on the existing devices.

As illustrated in FIG. 2, the protocol translation engine 200 includes a system bus electrical conformance module 210, Global Positioning System (GPS) module 220, outside temperature sensor 230, and network interface 240. A processor 250 is also provided for authenticating the owner, receiving cryptic data, and timestamping the data. The processor 250 also performs system data lookup, code translation, and enriches and translates events to translation component events. If an alert is received, then the processor 250 runs XSLT and sends data via the network interface 240 to the pervasive devices 160. If a request is received, then the processor 250 collects control point data, translates the data via XSLT, and presents the data via the network interface 240 to the pervasive devices 160. Moreover, the processor 250 provides an opportunity to request integrated services applied to the translation component data (i.e: GOOGLE™ map, manufacturer information, repair companies, tow companies (AAA)).

The protocol translation engine 200 also includes a flash random access memory (RAM) 260 for security and personalization (i.e., owner name, address, phone number, system information (e.g., make, model), and user ID and password). The flash RAM 260 also assists the protocol translation engine 200 with system tables, code translations, and XML/XSLT processing algorithms.

In one embodiment of the invention, a user of the system is authenticated using standard security authorization protocols and methods. Cryptic data (also referred to herein as “first data” or “control point data”) in a proprietary protocol (also referred to herein as “first protocol” or “cryptic protocol”) is received from the target system and time-stamped. As described in further detail below, system data lookup and code translation is performed. Additionally, object data for the monitored systems is converted to an enriched textual representation (also referred to herein as “second data”, “translation component messages”, or “translation component objects”) in structured XML (also referred to herein as “second protocol”). The translation is performed using the translation component, wherein the translation component messages are routed through Extensible Stylesheet Language Transformations (XSLT) for transmission to a pervasive device as translated data (also referred to herein as “third data”) in HTML (also referred to herein as “third protocol”).

The user can configure alert levels and other system state monitoring control variables via the pervasive device. Thus, the present invention can monitor the system network for thresholds on monitoring variables under its observation. The thresholds are in the form of first data, or they are translated into the form of first data. When an alert is encountered, the object data is converted to translation component messages, sent through XSLT, and delivered to the user's pervasive device, which may or may not be acted upon. In one embodiment, the sensor alerts have pre-set thresholds within the proprietary network; in another embodiment, the thresholds are set by the user; in yet another embodiment, the thresholds are pre-set and set by the user. An embodiment of the invention allows monitoring of alerts requested by the consumer via connection to the communications network gateway. Where appropriate control points are established within the proprietary system, end-user requests of control point data thresholds are provided that are selectable by the end user. Windshield washer fluid levels at 50% and 10% are examples of control point data thresholds.

If a request is received from the user, some or all of the control point data is collected. Requested control point data is translated via XSLT and the data is presented via a network interface 132 to the pervasive device. Further, opportunities are provided to request integrated services applied to the translation component data, for example, GOOGLE™ Map, manufacturer information, repair companies, towing companies.

Accordingly, the translation component is utilized to convert proprietary object data from the proprietary systems being interfaced to structured Extensible Markup Language (XML) that follows the translation component/XML schema that can be stylized using XSLT to support any pervasive device targeted. End-user configuration, via the pervasive devices, of alert levels in monitored target systems is provided. Where appropriate control points are established, end-user manipulation of control points are provided that are changeable by the end-user. Further, information from the present system can be adapted to be securely transmitted across a local area network (LAN), metropolitan area network (MAN), or wide area network (WAN).

FIG. 1 illustrates a system including a plurality of sensors 120-128 for monitoring a system network 110 having a protocol/metadata engine according to one embodiment of the invention. More specifically, a system 100 includes sensors 120, 122, 124, 126, and 128 connected to a system network 110. The sensors 120-128 are utilized to monitor other devices (e.g., sensor 120 in a car, sensor 122 in a home, and sensor 124 in a boat) and notify the system network 110 of thresholds reached. The network can make a request of the sensor to check certain critical systems throughout the day and/or the sensor can send alerts to the system network 110, for example, to activate a warning light or display a code.

As described above, a protocol/metadata engine 130 is also provided, which has an electrical/mechanical conformance to interface to the system network 110. The protocol/metadata engine 130 includes the translation component. Steps performed by the translation component include: system setup/personalization and security; identifying control points to be monitored; initializing the system; in the presence of an alert, executing an identified service handler; and, in the presence of a request, executing the identified service handler. At least one embodiment of the invention provides a gateway protocol translation function 132 that enables the data from the sensors 120-128, routed within the system network 110, to be translated and enriched with metadata.

Furthermore, the system 100 includes an XSLT component 140 for receiving the translated data. As described above, the translated data is routed through XSLT for transmission to an end user. The translated data is sent to a security component 150 before it is sent to the user interfaces 160 (e.g., cell phone display). For example, Wi-Fi Protected Access (WPA) or other personal security protocols are used to uniquely identify the use/owner of the system to enable private, controlled access. As described above, information from the present system can be adapted to be securely transmitted across a LAN, MAN, or WAN.

As described above, the protocol translation engine 200 enriches the data with the specialized metadata and translates between the proprietary protocols and common pervasive protocols. More specifically, a lookup table (also referred to as a map, an associative array, or a dictionary) is a list of key-value pairs. For example, a lookup table is created that contains the cryptic code received (key value) in one column. The adjoining columns include corresponding manufacturer descriptions, recommended parts, temperature ranges for parts, immediate stop or continue operation of vehicle, and recommended actions by the manufacturer. This will provide more actionable information versus simply the code by itself.

The translation component provides an XML-based specification for manufacturers' service and user manuals (such as automobile manuals) that provide comparison of the cryptic codes to the descriptions in the manufacturers manuals, then, based on the description, adds additional information that will be helpful for the end-user.

For example, an end-user has an “event” or code sent when her automobile radiator level reaches a predetermined threshold. Based on the radiator threshold “event”, the translation component checks the lookup tables that contain the manufacturers' manuals to provide the kind of radiator fluid recommended for the make/model of the end-user's vehicle. If the manufacturer recommends an immediate pull over and stop of the vehicle, this information is also provided to the end-user. If temperature is a factor in the selection of the appropriate fluid, the temperature is checked, and the correct recommendation is presented to the end-user. In addition, the GPS system included in the after-market installed device (Code translation engine) is checked in order to get an accurate account of where the end-user is located. Then, local service stations, automobile dealers and tow companies with addresses within a 25-50 mile radius of the end-user is searched in yellow page books embedded into the system (with a limit of five or ten per page, and a maximum of twenty displayed). The phone numbers, addresses and distance away are provided. The end-user can then place a call or drive to the locations for immediate repair of the problem. All of this information is sent to the end-user's PDA, cell phone or other pervasive device defined at the time of installation of the device.

In the above example, table lookups of the cryptic code and adjoining columns was performed (i.e., description, parts information, temperature sensitive, immediate stop—yes or no, recommended procedure. Additional metadata was added to the code received. For instance, for “radiator fluid threshold reached” was added to the “description” code; type of fluid to use was added to the “parts information” code; “NO” was added to the “temperature sensitive part information” code; and, “NO” was added to the “immediate stop” code; and, “get to service station or dealership, immediately” was added to the “recommended procedure” code. Further metadata was added to the “location of user”, “location of available service stations, dealerships or tow companies”, and “addresses and phone numbers for assistance” codes.

The above example also performed translation of the XML data through XSLT to send the complete package of information to the end-user's pervasive device. Full textual messages with the event that occurred, recommended actions, and available help in the local area was provided to the end-user

The translation component (embedded in the code translation engine) can also receive input from the consumer. Specifically, input received from a PDA is translated by XSLT to go from HTML to structured XML data. For example, an end-user requests the system to check the status of radiator fluid level. If the manufacturer has multiple thresholds defined in the sensors, the last threshold reached is provided. For instance, if the light on the dashboard turns on when the threshold is at 50%, but there are other thresholds defined at 70% and 60%, information about the last threshold reached is provided. Thus, it the fluid level is currently at 60%, the end-user may want to service her automobile sooner. The end-user can then request the parts information and local companies to be displayed to her pervasive device to address the radiator fluid before the 50% threshold is reached.

Proprietary codes are typically maintained by the manufacturer as cryptic codes contained within the proprietary network, and are decipherable by specialized personnel with specialized equipment. An embodiment of the invention analyzes the manufacturer's proprietary codes and instruction manuals to identify data elements to be presented to the end-user. This information is used to create a markup vocabulary generating structured XML data. This vocabulary is further enriched with comparisons against the GPS and temperature data to output additional, selectable, relevant data elements. XSLT is then used to convert the XML document into an HTML document for rendering in a browser on the PDA.

The translation component includes XML tags and supports a variety of manufacturer definitions to be further enriched with additional relevant metadata. When compared with a general-purpose markup vocabulary, the translation component documents are specific to the manufacturer definitions. The translation component documents also correlate additional environmental and location data to the vocabulary, and present the data in a readable format for presentation on a consumer's pervasive device.

The translation component enables consumers to receive real-time alert information with additional recommendations from the manufacturer. When an event occurs, end-users don't always have the appropriate information, and must consult with other authorized service providers to take appropriate action on the events. An embodiment of the invention allows the end-user to receive pertinent, relevant information about the event, and also provides the resources and recommended parts information to take appropriate action. All of this is provided on the consumer's pervasive device without any other service provider being directly involved in the communication. The end-user pervasive device contacted can be determined by the end-user.

An embodiment of the invention can be retrofitted to older vehicles or devices (with the network capability). In such an embodiment, the device will be compatible with the IEEE and EMC standards (Guide to the demonstration of conformity for aftermarket ESAs to the motor vehicle EMC Directive 2004/104/EC) per device connected to in order to protect circuitry and fuses on the existing devices.

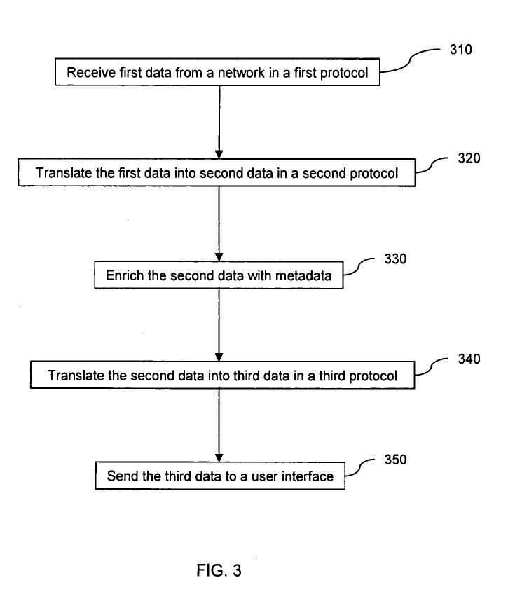

FIG. 3 is a flow diagram illustrating a method for system monitoring control point conversions to pervasive device objects according to one embodiment of the invention. More specifically, the method receives first data from a network, wherein the first data is in a first protocol (also referred to herein as “proprietary protocol” or “cryptic protocol”) that is not readable by a user interface of a pervasive device (310). The first data is translated into second data in a second protocol (also referred to herein as “structured XML”) that is not readable by the user interface (320). The method accesses code lookup tables within the translation component to translate the first data into the second data.

The second data is enriched with metadata that is specific to the first data, wherein the metadata is obtained from the translation component (330). The metadata includes, for example, a warning, instructions, contact information for a support specialist, a map, global positioning satellite data, parts information, and/or temperature data. The second data is translated into third data in a third protocol (also referred to herein as “HTML”) that is readable by the user interface (340). The method creates XSLT's to translate the second data to the third data and sends the third data to the user interface (350).

The method further includes receiving user-defined criteria from the user interface, and analyzing the first data to determine if the first data conforms to the user-defined criteria. The third data is only sent to the user interface if either the first data conforms to the user-defined criteria, or the first data and/or the third data is requested by the user interface.

At least one embodiment of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, at least one embodiment of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

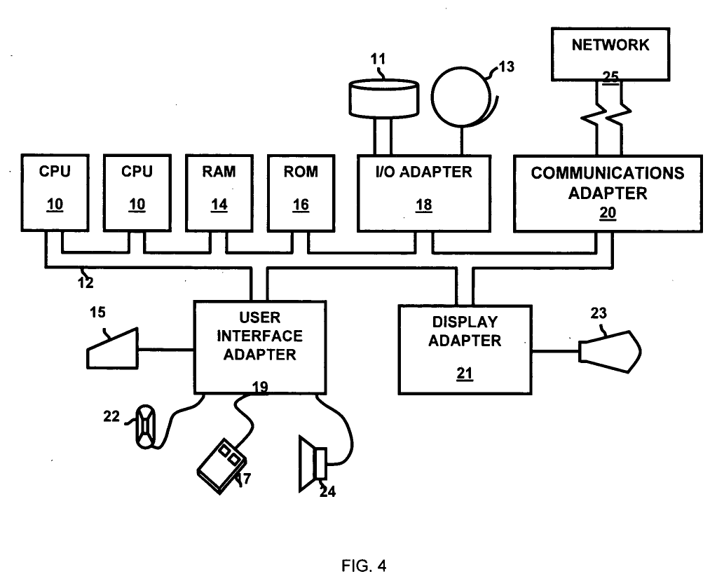

A representative hardware environment for practicing at least one embodiment of the invention is depicted in FIG. 4. This schematic drawing illustrates a hardware configuration of an information handling/computer system in accordance with at least one embodiment of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Accordingly, the present invention provides monitoring control point conversions for translation component objects. A method according to one embodiment of the invention interfaces to a network and provides gateway protocol translation functions that enable sensor data, routed with the system network, to be translated and enriched using specialized metadata. The method provides personalized and secured access to the system being monitored and supports alerts and real time queries of the system. A protocol translation engine is provided that enriches the data using metadata that translates between proprietary protocols and common pervasive protocols.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method, comprising:
receiving first data from a network, wherein said first data is in a first protocol that is not readable by a user interface;
translating said first data into second data in a second protocol that is not readable by said user interface;
enriching said second data with metadata;
translating said second data into third data in a third protocol that is readable by said user interface; and
sending said third data to said user interface.

2. The method according to claim 1, wherein said translating of said first data comprises accessing code lookup tables within a translation component to translate said first data into said second data.

3. The method according to claim 2, wherein enriching of said metadata comprises obtaining said metadata from said translation component.

4. The method according to claim 1, wherein said enriching of said second data comprises enriching said second data with metadata that is specific to said first data.

5. The method according to claim 1, wherein said metadata comprises at least one of a warning, instructions, contact information for a support specialist, a map, global positioning satellite data, parts information, and temperature data.

6. The method according to claim 1, wherein said translating of said second data comprises creating specialized extensible stylesheet language transformations (XSLT's) to translate said second data to said third data.

7. The method according to claim 1, further comprising:
receiving user-defined criteria from said user interface;
analyzing said first data to determine if said first data conforms to said user-defined criteria, wherein said sending of said third data only occurs if at least one of:
said first data conforms to said user-defined criteria, and
at least one of said first data and said third data is requested by said user interface.

8. A method, comprising:
receiving first data from a network, wherein said first data is in a cryptic protocol that is not readable by a user interface;
translating said first data into second data in a structured XML that is not readable by said user interface, wherein said translating of said first data comprises accessing code lookup tables within a translation component to translate said first data into said second data;
enriching said second data with metadata;
translating said second data into third data in HTML that is readable by said user interface; and
sending said third data to said user interface.

9. The method according to claim 8, wherein enriching of said metadata comprises obtaining said metadata from said translation component.

10. The method according to claim 8, wherein said enriching of said second data comprises enriching said second data with metadata that is specific to said first data.

11. The method according to claim 8, wherein said metadata comprises at least one of a warning, instructions, contact information for a support specialist, a map, global positioning satellite data, parts information, and temperature data.

12. The method according to claim 8, wherein said translating of said second data comprises creating specialized extensible stylesheet language transformations (XSLT's) to translate said second data to said third data.

13. The method according to claim 8, further comprising:
receiving user-defined criteria from said user interface;
analyzing said first data to determine if said first data conforms to said user-defined criteria, wherein said sending of said third data only occurs if at least one of:
said first data conforms to said user-defined criteria, and
at least one of said first data and said third data is requested by said user interface.

14. A computer program product comprising computer readable program code stored on computer readable storage medium embodied therein for performing a method, comprising:
receiving first data from a network, wherein said first data is in a first protocol that is not readable by a user interface;
translating said first data into second data in a second protocol that is not readable by said user interface;
enriching said second data with metadata;
translating said second data into third data in a third protocol that is readable by said user interface; and
sending said third data to said user interface.

15. The computer program product according to claim 14, wherein said translating of said first data comprises accessing code lookup tables within a translation component to translate said first data into said second data.

16. The computer program product according to claim 15, wherein enriching of said metadata comprises obtaining said metadata from said translation component.

17. The computer program product according to claim 14, wherein said enriching of said second data comprises enriching said second data with metadata that is specific to said first data.

18. The computer program product according to claim 14, wherein said metadata comprises at least one of a warning, instructions, contact information for a support specialist, a map, global positioning satellite data, parts information, and temperature data.

19. The computer program product according to claim 14, wherein said translating of said second data comprises creating specialized extensible stylesheet language transformations (XSLT's) to translate said second data to said third data.

20. The computer program product according to claim 14, further comprising:
receiving user-defined criteria from said user interface;
analyzing said first data to determine if said first data conforms to said user-defined criteria, wherein said sending of said third data only occurs if at least one of:
said first data conforms to said user-defined criteria, and
at least one of said first data and said third data is requested by said user interface.
